(19) United States
(12) Patent Application Publication
(10) Pub. No.: US 2008/0147999 A1
(43) Pub. Date: Jun. 19, 2008

(54) Method and system for data storage, and corresponding computer-program product

(75) Inventors: Donata Rosaria Maria Nicolosi, Catania (IT); Manuela La Rosa, Giarre (IT); Giovanni Sicurella, Mascalucia (IT)

Correspondence Address: SEED INTELLECTUAL PROPERTY LAW GROUP PLLC, 701 FIFTH AVENUE, SUITE 5400, SEATTLE, WA, 98104-7092, US

(73) Assignee: STMicroelectronics S.r.l., Agrate Brianza (IT)

(21) Appl. No.: 12/001,345

(22) Filed: Dec. 10, 2007

(30) Foreign Application Priority Data
Dec. 15, 2006 (IT) TO2006A000888

(51) Int. Cl. G06F 12/06

(52) U.S. Cl. 711/161; 711/E12.078

(57) ABSTRACT

A system architecture for storing and retrieving data includes a storage device organized in a plurality of blocks. There is provided at least one classifying circuit for organizing the data to be stored in classes according to their content, associating to the data thus organized class-of-content identifiers. The input information can hence be stored, according to the class-of-content identifiers, in memory blocks having appropriately set addresses. The data, with associated thereto a given class-of-content identifier, are stored in at least one corresponding block.

### TECHNICAL FIELD

The present disclosure generally relates to techniques for data management in memory architectures.

The present disclosure has been developed with particular but not exclusive attention paid to its possible application to memory architectures of a non-volatile type and of large dimensions.

### BACKGROUND INFORMATION

The continuous demand for systems with high mass-storage capacity (with capacities of the order of terabytes and beyond) stimulates the search for increasingly new techniques for the storage and retrieval of data.

The possibility of storing large sets of data belonging to environments of heterogeneous information opens the way to ad-hoc architectures for management of knowledge. These architectures must be able to co-operate with mass-storage systems of large dimensions so that the dimensions of the data are less critical than the time necessary for retrieval of the information when the corresponding address is not precisely known.

Conventional computers are characterized by architectures in which storage and retrieval of data is performed via direct addressing or via tables containing information regarding the locations of the files.

The most recent applications require storage and management of rather large amounts of data, such as alphanumeric data, images, and text, which entails correspondingly long access times: when the dimensions of the storage devices increase, it is in fact more difficult to make efficient use thereof. In addition to this, when the user looks for a specific data item without knowing its location precisely, but knowing, instead, only a part of the information (for example, part of a text or else some characteristics of the content of a file), the search, in particular on a very large mass-storage system (VLMSS), involves a very long time if the data are sought sequentially.

In this context, it becomes important to be able to develop new policies for data storage and retrieval.

Various current solutions (the most widely used technique is the so-called “inverted-files method”) proposed for the purpose of performing a data search based upon the content in mass-storage devices are based upon software techniques that in general are not very effective.

A hardware solution proposed for the purpose of performing a content-based search is constituted by the so-called “Content-Addressable Memories” (CAMs). This is a particular type of memory used in those applications in which it is necessary to make available a very fast search. In standard computer memories, when the user supplies a memory address, the memory restores the data stored at said address; instead, a CAM is designed so that the user supplies the data, and the CAM carries out a search in parallel on its entire memory to see whether the data in question are stored in some part of the memory. If these data are retrieved, the CAM restores a list of one or more storage addresses where a certain word has been retrieved, and in certain architectures restores also the data or other associated data elements. The operations of search in the context of a CAM are performed to a large extent in parallel on the entire memory in a single operation, which is hence much faster than what occurs in a random-access memory (RAM). As compared to the approaches of an algorithmic type, the strong point of CAMs hence lies in the very high search throughput.

However, CAMs are not exempt from various drawbacks.

The first of these is represented by the cost, since each individual bit of memory in a completely parallel CAM must have associated a respective comparison circuit so as to be able to detect a correspondence between the bit stored and the bit used as input datum for the search.

In addition to this, the outputs indicating a correspondence coming from each cell in a given word must be combined so as to supply a complete signal of correspondence of the given word. The corresponding additional circuit increases the physical dimensions of the chip of the CAM and, accordingly, the costs of production. A very critical bottleneck is then represented by the high power consumption due to the large number of comparison circuits activated in parallel at each clock cycle.

As a consequence of this, CAMs are used only in special applications, in which the speed of search required cannot be achieved using less costly techniques. CAMs are not suited then in general to providing VLMSS circuits and moreover use hardware for completing the search in a single cycle, which gives rise to a constant complexity in time of an O(1) type.

In view of the addition of the comparison circuit for each hardware memory cell, in order to obtain a different balancing between speed, size of memory, and cost, some embodiments emulate the function of a CAM by implementing a normal tree search or else by resorting to hardware solutions that are based upon the replication or adoption of pipeline structures for increasing the performance, according to criteria frequently used in routers.

The document U.S. Pat. No. 6,831,850 describes a method and a device where a CAM device is partitioned into blocks and in which only those blocks belonging to a class or type corresponding to that of the data being sought are selectively addressed via a selection circuit. Consequently, the search is performed only on the blocks of the CAM each time enabled, so reducing the power absorption.

This solution strictly refers to CAM devices, and consequently adoption thereof cannot be proposed for VLMSSs, since in any case excessively costly comparison would be required even though said circuitry is to be used only partially during each search operation. Furthermore, the storage operation is not adaptive according to the content of the data to be stored. The association of the indices is determined in a static way according to the amplitude of the data.

The solution described in U.S. Patent Application Publication No. 2004/0193740 enables storage of data in one from among a plurality of different storage resources that have different characteristics of capacity, accessibility, and functionality in regard to the user. In greater detail, storage of the data occurs in various different devices, such as for example on-line storage devices (disks of various types), storage devices of a quasi on-line type (for example, optical disks that reside on a juke-box or else tapes of a tape library), and off-line devices. All this is obtained, however, on the basis of manual actuation of the storage devices and of the corresponding driving units by a human operator.

### BRIEF SUMMARY

In the solution according to the known art discussed above, the storage mechanism is not adaptive, and moreover the system is basically conditioned by the requirements of storage and not of intelligent retrieval of the data.

From the foregoing, there emerges the need to have available solutions that are further improved to enable, in the context of a mass-storage system of large dimensions, operations of storage and retrieval of the data both on the basis of addresses and on the basis of the contents, at the same time enabling a complete compatibility with existing systems.

An embodiment of the present invention provides such an improved solution.

According to one embodiment of the present invention, a method for storing and retrieving data includes:

providing a storage device with a plurality of memory blocks;

organizing the data to be stored in classes according to their content; associating to the data thus organized class-of-content identifiers;

storing the data in said storage device at given addresses in said memory blocks according to said class-of-content identifiers, so that the data associated with a given class-of-content identifier are stored in at least one corresponding block; and

retrieving the data stored in said storage device:
(i) if the storage address is available, by retrieving the data at the respective storage addresses; or
(ii) if the storage address is not available, by seeking the data according to the corresponding class-of-content identifiers, conducting the search in the memory blocks corresponding to said class-of-content identifiers.

An embodiment of the invention also relates to a corresponding system architecture, as well as to a computer-program product that can be loaded directly into the memory of at least one computer and includes portions of software code for performing the method according to one embodiment of the invention when the product is run on a computer. As used herein, reference to such a computer-program product is to be understood as equivalent to reference to a medium that can be read by a computer and contains instructions for controlling a computer system for coordinating the implementation of the method according to one embodiment of the invention. The reference to “at least one computer” is evidently intended to highlight the possibility of implementing an embodiment of the present invention in distributed or modular form.

The claims form an integral part of the disclosure of the invention provided herein.

Basically, in one embodiment, the solution described herein enables storage and retrieval of data to be carried out both on the basis of addresses and on the basis of the content, with the assurance of complete compatibility with traditional storage systems.

In particular, once again in one embodiment, the solution described herein envisages the use of three fundamental parts: a mass-storage system of large dimensions (e.g., a VLMSS), a storage-management unit (SMU) and an associative memory (AM). A VLMSS is basically a system for the storage of data of an extended type with a logic partitioning in blocks addressed via an index. The partitioning can be of a hierarchical type. The SMU is able to perform operations of reading and writing in the VLMSS using the storage indices generated by the associative memory. The associative memory is an intelligent unit that correlates the information stored with locations in the VLMSS and modifies its structure in an adaptive way according to the data received. With reference to each datum to be stored in the VLMSS as entry, the associative memory generates a storage index both on the basis of each new entry, according to the data stored previously. The management unit takes as inputs the storage indices generated by the associative memory, translates them into the physical addresses of the blocks and, preventing collision with storage locations occupied, sets under way the procedure of writing in the VLMSS. The search operation can be conducted both using the address of the location and adopting knowledge-aided retrieval mechanisms, in which the input storage index or entry is identified by the associative memory, which transfers this information to the storage-management unit. This unit starts the operations of search and retrieval of the data in the VLMSS. When the address is known, access to the data is made on the basis of the address according to address-based storage/retrieval policies. However, the storage policy adopted in the solution described herein regulates data management and renders retrieval of the data more efficient when precise information regarding the location of the data in the VLMSS is not available.

If compared with the related art, the solution described herein introduces an innovative solution for adaptive storage and retrieval of the data within a VLMSS device. Basically, the storage space within the device is considered as a set of blocks of particular dimensions. The data are stored according to their content and, in particular, data with characteristics in common are stored in the same block of the mass-storage device. Accordingly, retrieval of the data within the mass-storage device, when complete information regarding the address is not available, can be implemented by carrying out a search just in the blocks that contain data with the same characteristics as the data that are sought. In this way, it is possible to reduce the time for data retrieval in all those applications in which a reduced search time constitutes a useful characteristic.

### BRIEF DESCRIPTION OF THE SEVERAL VIEWS OF THE DRAWINGS

One or more embodiments of the invention will now be described, purely by way of non-limiting and non-exhaustive examples, with reference to the annexed figures of drawing, in which:

FIG. 1 is a general block diagram of the example architecture according to an embodiment of the solution described herein;

FIG. 2 represents execution of a generic data-storage operation within the structure of FIG. 1 according to one embodiment;

FIG. 3 is a flowchart of the data-storage operation according to one embodiment;

FIG. 4 exemplifies a possible organization of the data at the metadata level according to one embodiment;

FIG. 5 is a schematic illustration of the data-retrieval operation in an embodiment of the solution described herein;

FIG. 6 is a flowchart corresponding to the data-retrieval operation represented in FIG. 5 according to one embodiment;

FIG. 7 illustrates an example of storage of the data and updating of the index associated to the block according to one embodiment; and

FIG. 8 is a flowchart corresponding to the example illustrated in FIG. 7 according to one embodiment.

### DETAILED DESCRIPTION

In the following description, numerous specific details are given to provide a thorough understanding of embodiments. The embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the embodiments.

Described in what follows are some examples of solutions for the storage and retrieval of data that can be implemented both at a hardware level and at a hybrid software/hardware level and overcome the intrinsic limitations of the solutions according to the known art, of which mention was made in the introductory part of the present description.

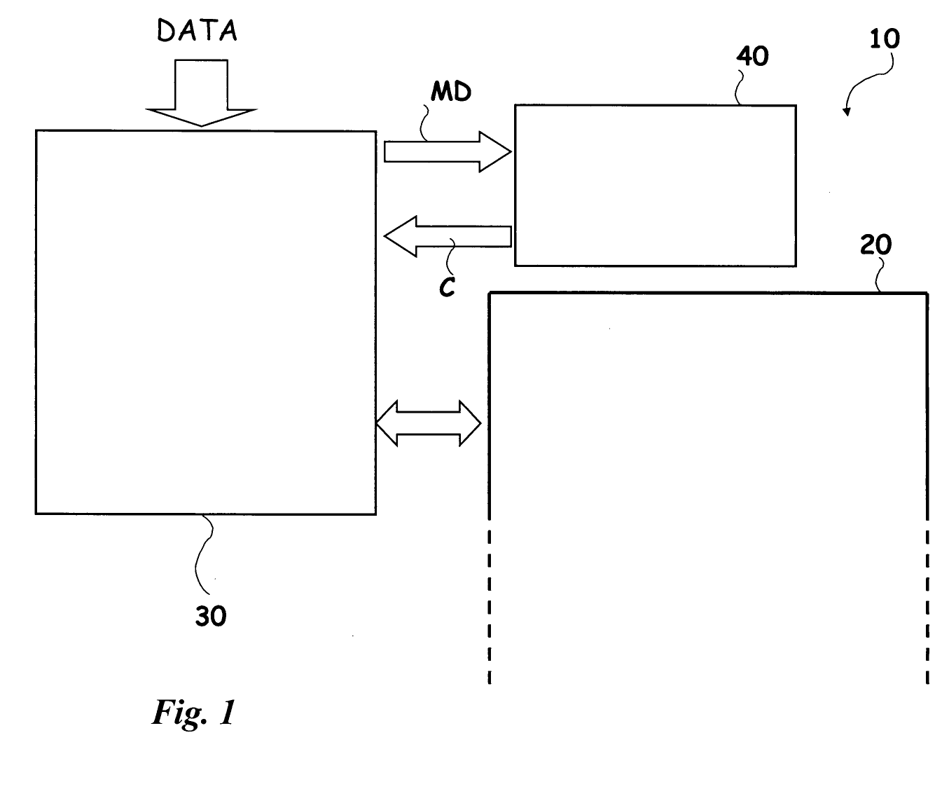

Basically, according to the solution schematically illustrated in FIG. 1, a system for the storage and retrieval of data, designated as a whole by 10, includes three elements, namely:
a mass-storage system 20 of very large dimensions (for example, of the order of terabytes) of the type commonly referred to as VLMSS (Very Large Mass-Storage System);
a storage-management unit (SMU) 30; and
an associative memory (AM), designated by the reference number 40.

It will be assumed in general that the data to be stored (whatever they may be) enter the system 10 through the unit 30.

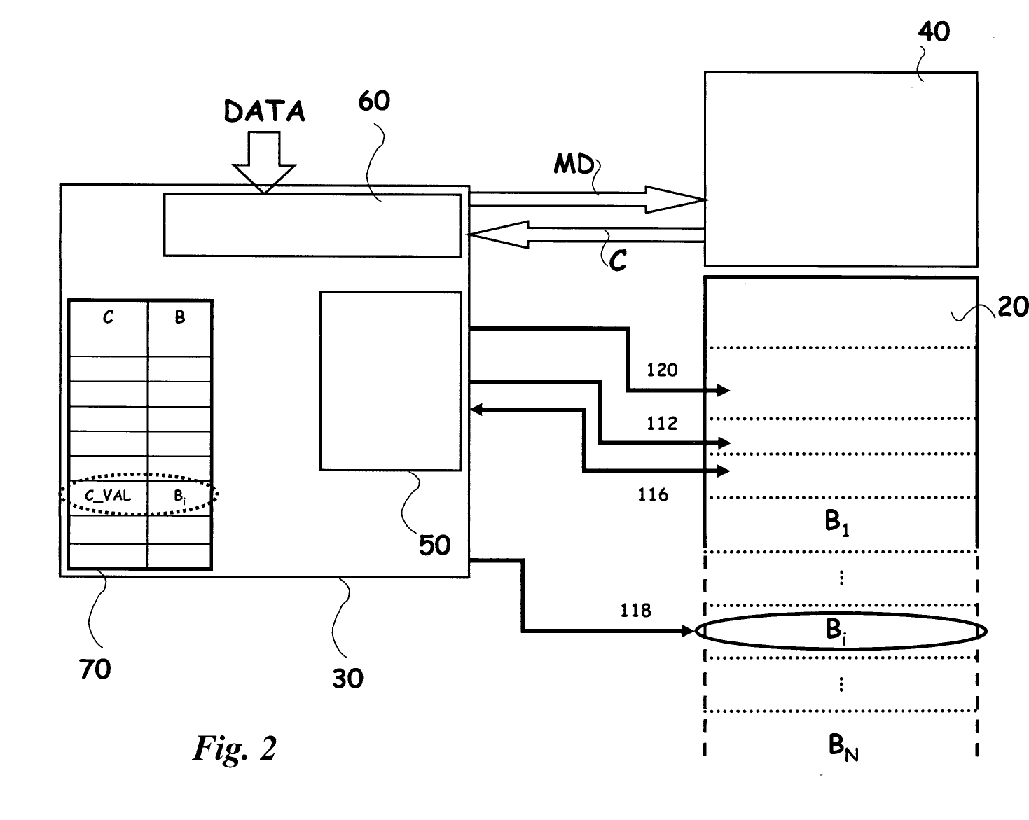

Present within the unit 30, in addition to a read/write (R/W) unit of a traditional type, designated by 50 in FIG. 2, is a block 60, which (operating in a way in itself known, for example via operations of parsing or the like) is able to extract some typical characteristics of the input data.

In general, to simplify treatment (without this, however, necessarily implying any limitation of the scope of the invention), it may be assumed for an embodiment that the input data have, in some way, associated “metadata” representing the content of the data as a whole.

Of course, in another embodiment, it may also be considered that the aforesaid metadata, instead of being present in the input data so as to be extractable through the block 60, are inserted (by an insertion block, not specifically illustrated, which can be considered in effect included in the unit 30) in the input data at the moment when these are entered into the system 10.

Whatever the specific solution adopted, the aforesaid metadata, designated generally by MD, are sent to the associative memory 40, which evaluates them, functioning as a classifier. In practice, the associative memory 40 receives the metadata and classifies the input data, assigning to them a class-identifier index; for example (and it is emphasized that this is merely an example, which hence must not be interpreted as in any sense limiting the scope of the invention), said identifier may be constituted by the index C. Said index represents the element identifying a set of information already stored or to be stored and hence does not necessarily coincide with any one of them. The value of said index C is obtained from an operation of processing of the information contained in the block indexed thereby.

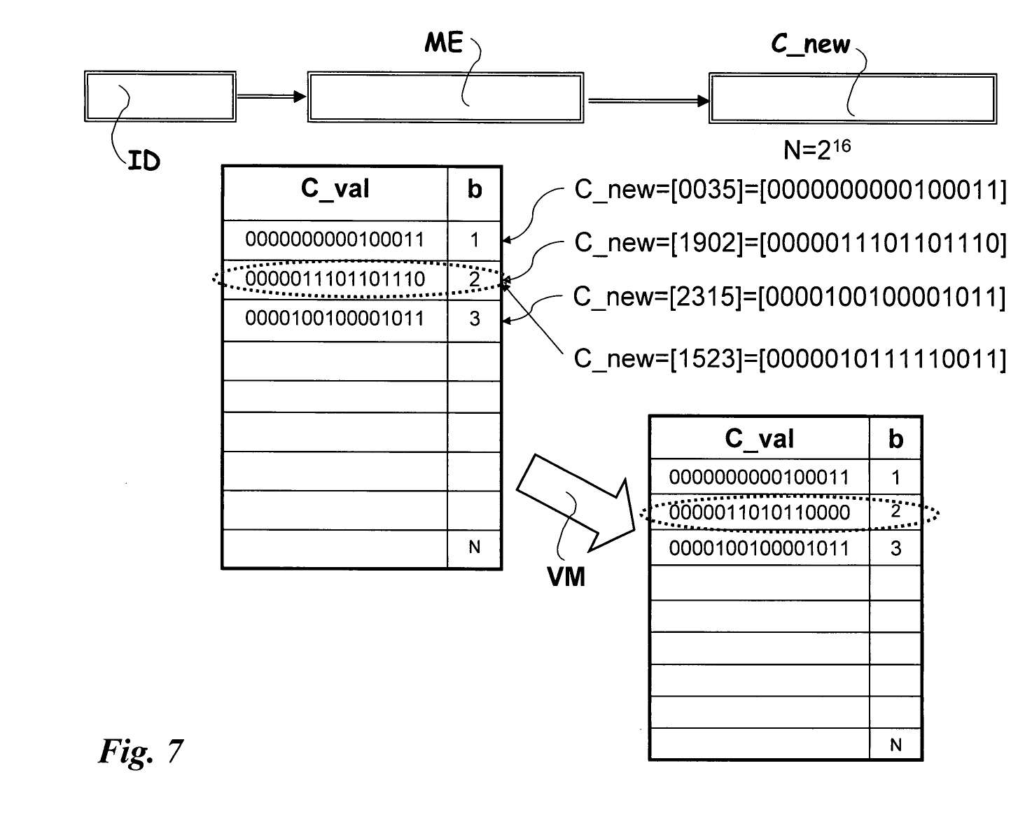

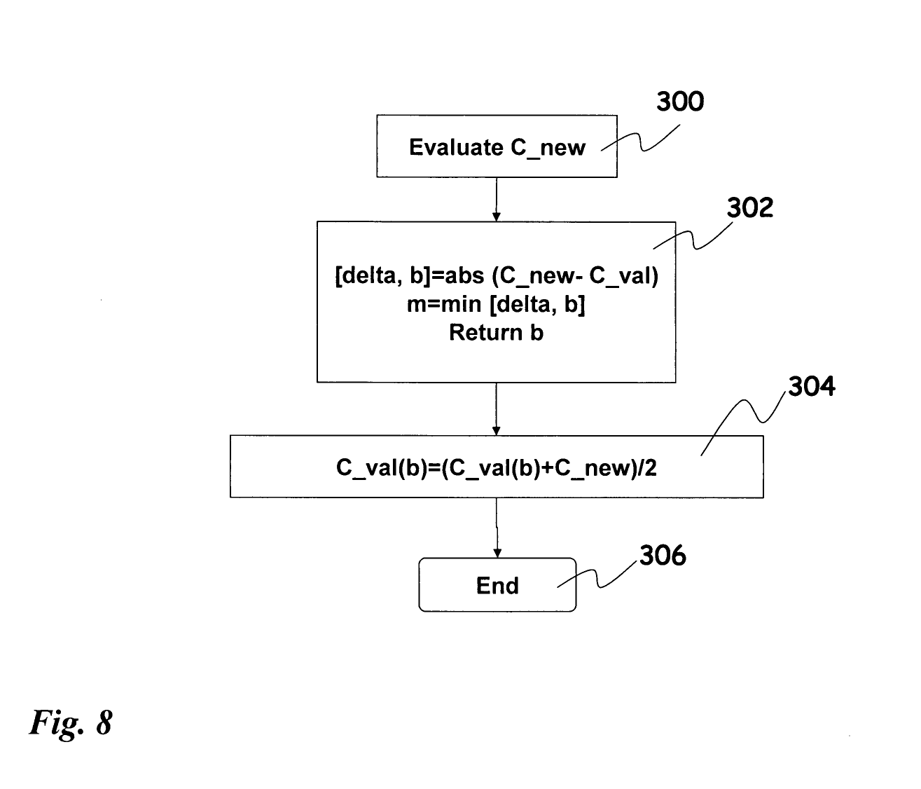

A simple clarifying example is illustrated in FIGS. 7 and 8, where the identifier is constituted by the mean value between the current index C_val and the new value C_new associated to the information to be stored.

Specifically (FIG. 7), ID designates the input data, ME the operation of metadata extraction, and C_new indicates as a whole the result (16-bit input data (C_new)).

In FIG. 8, block 300 represents, instead, the evaluation of C_new, whilst block 302 represents a tabular search operation aimed at choosing the index “b” with index value C_val with the minimum distance from the input value C_new.

Block 304 represents, instead, the operation of updating C_val(b) with the mean value:

C_{—}val(b)=(C_{—}val(b)+C_new)/2.

Finally, block 306 indicates the end of this process.

The associative-memory block 40 can be provided both at a software level and at a hardware level. For example, if the software option is adopted, it is possible to resort to techniques of clustering that implement methods of the type known as C-means or K-means, as described, for example, in:
J. C. Bezdek: “Pattern Recognition with Fuzzy Objective Function Algorithms”, New York: Plenum Press, 1981.
C. M. Bishop: “Neural Networks for Pattern Recognition”, Oxford, England: Oxford University Press, 1991, Chap. 5.

Alternatively, the action of clustering can be performed via a hardware device that provides, for example, a so-called “motor map” as illustrated, for example in H. Ritter, et al., “Neural Computation and Self-Organizing Maps”, Reading, Mass.: Addison-Wesley, 1992. Whatever the specific solutions adopted, the input is usually evaluated as a vector, and the result of the treatment operation performed by the associative memory 40 also takes the form of an output vector C (for example, a vector of centroids), which is returned to the unit 30 for being associated to the input data.

In this way, the data can be stored in the mass-storage device 20 according to an index value. In particular, each class identified within the data at the level of metadata corresponds to a certain block Bᵢ. Consequently, in ordering the data that are stored in the device 20, the unit 30 takes into account the aforesaid indices, seeking the block corresponding to the index that each time has been evaluated by the associative memory 40.

It is evidently possible to determine at least two cases.

In the first case, the index is retrieved from a table 70 accessible by the unit 30, listed in which, in a coordinated way, are the indices (centroid values C (C_val) corresponding to the block number B (Bᵢ)). In this case, the unit 30 simply reads the block number Bᵢ, checks in the list of the free addresses within the device 20 to see which is the first address available within the block selected, and stores the individual datum (entry) at said address.

In the second case, i.e., if the value of the index is not retrievable from the table 70, the unit 30 chooses an index value that is as close as possible to the one evaluated and carries out the storage operation in the corresponding block, following the procedure described previously. In this case, the value of the index is updated, taking into account the new value (for example, calculating the mean value).

As a result, the reference table 70 is not static, but changes according to the data stored. In both of the above two cases, normal operations of writing, such as the one known as “file-allocation table” (FAT) and updating of the table of the freely available spaces are performed.

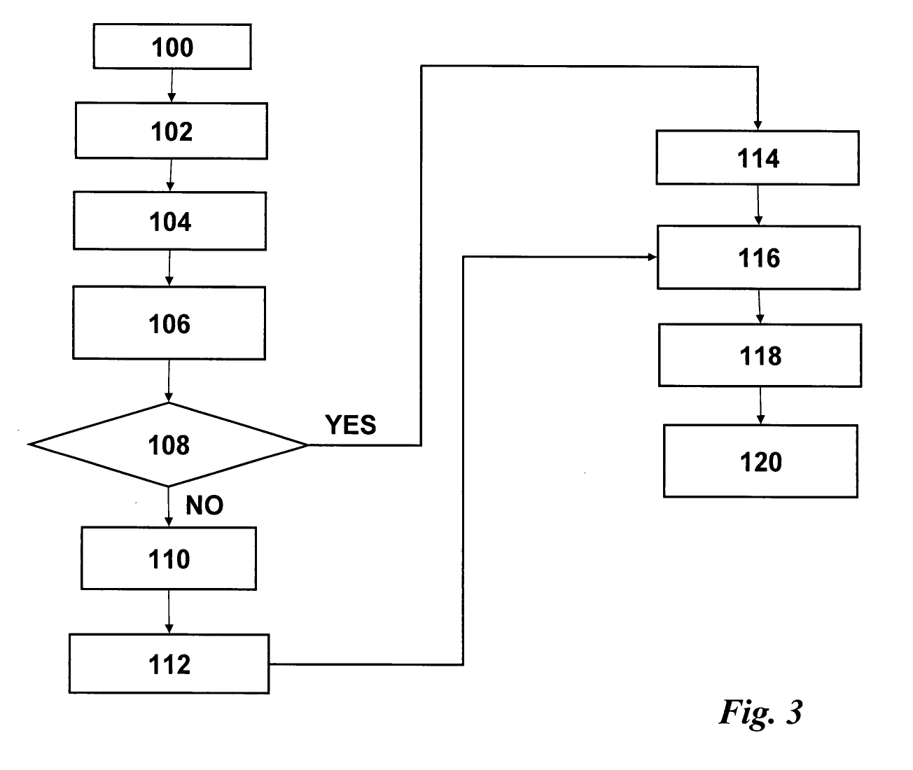

The flowchart of FIG. 3 illustrates in greater detail the sequence of operations performed during storage of the data.

In particular (FIG. 3), block 100 indicates an input file, whilst block 102 indicates in general the operation of extraction of the metadata that are to be passed to the associative memory 40 for evaluation, in a step 104, of the corresponding identifiers (for example, the centroids). Block 106 represents the operation of search for the value of the centroid in the blocks/centroids table.

The step 108 corresponds to the verification, already mentioned previously, e.g., the check for the presence of the centroid value in the table.

If it is not present, in a step 110 the block number with a centroid value that is closest to the estimated value is extracted, and finally, in step 112, the blocks/centroids table is updated.

Instead, if the step 108 yields a positive result (e.g., the centroid value is present in the table), then, in a step 114, the number of the block is extracted from the table.

Whatever the path followed, in a step 116 the first available address of the block selected is read from the list of the available addresses, and then, in a step 118, the data file is written at the address selected. Finally, in a step 120, the FAT is updated.

For greater clarity of representation, steps 112, 116, 118 and 120 have been represented also in the form of arrows indicating the corresponding flows of information in FIG. 2.

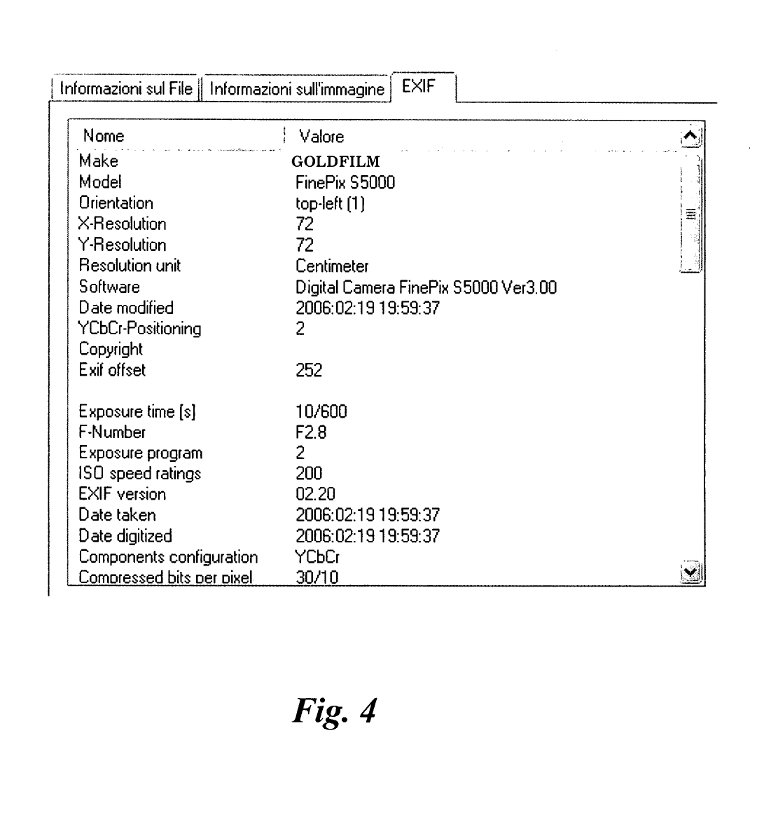

FIG. 4 represents an example of a data-storage operation, illustrated with specific reference to an application in which the input data are constituted by an image file that contains metadata tags of an exif type. The tags contained in the exif standard are rich in information regarding the image (for example, date, time, camera adjustments, etc.). These metadata can be extracted from block 60 for being supplied to the associative memory 40, which classifies the input data, assigning thereto the corresponding index values (for example, the centroid). The unit 30 looks for this value in the centroids/blocks table and performs the operation described previously for the general case.

Once the data have been stored as described previously, said data can be sought, whenever required, according to two different procedures.

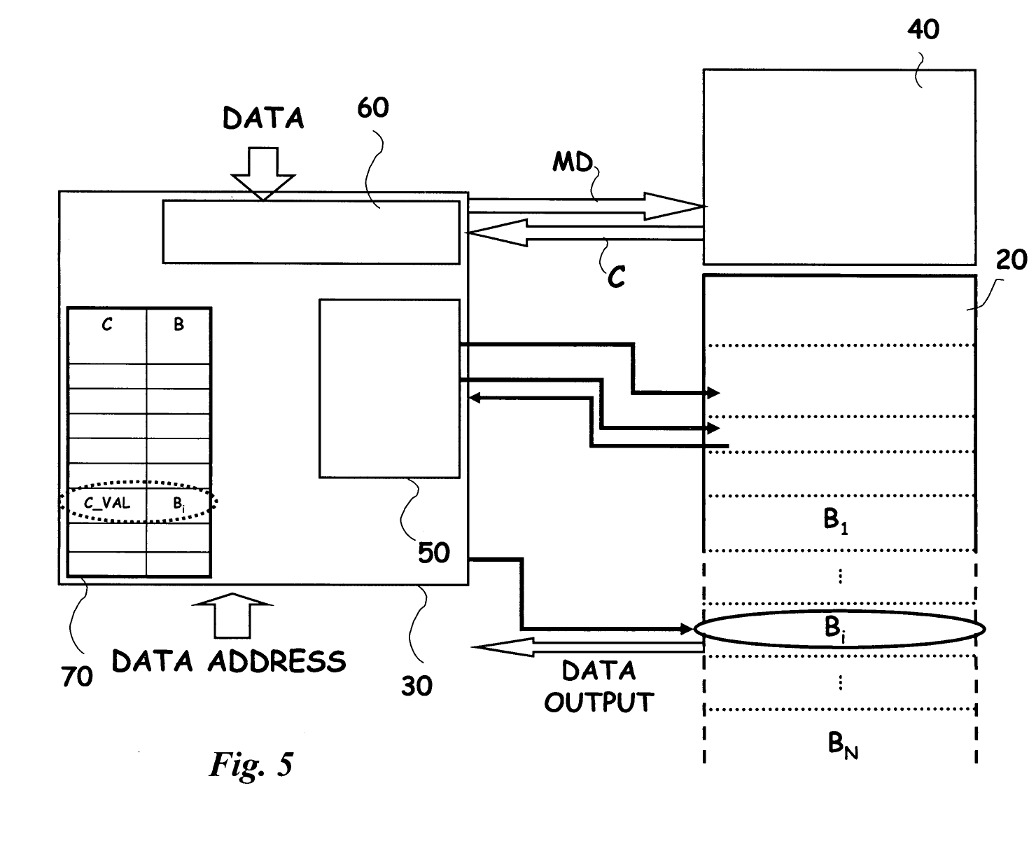

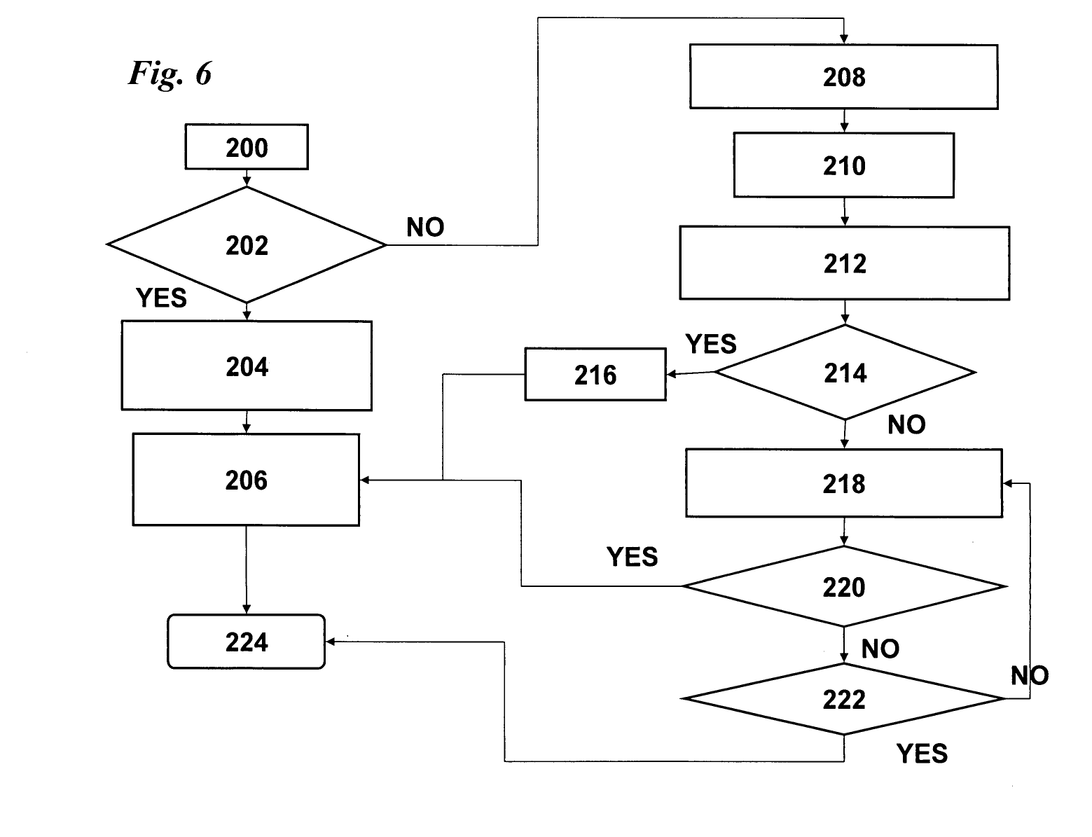

These two possible modes of operation are represented in a coordinated way in FIGS. 5 and 6.

On the assumption of starting from an input file represented by block 200, in a step 202 a check is made to see whether the user has available information regarding the address of the data to be sought.

If so (e.g., the address is known), in a step 204 the physical address of the data is read from the FAT, and, in a step 206, the data are found in a direct way.

If, instead, the user has available only incomplete information regarding the data that he is seeking (output NO from step 202), said information, which is made available basically in the form of a metadata file in a step 208, is subjected, in a step 210, to an index evaluation by the associative memory.

According to the value found, in a step 212 the value of the centroid is sought in the blocks/centroids table, and, in a step 214, it is verified whether the centroid value is recorded in the table.

If it is, in a step 216, the unit 30 starts to look for the data in the corresponding block, carrying out the search in the entire block until it finds the desired file.

If the step 214 yields, instead, a negative result, another block is chosen according to a predefined rule (for example, the block with the closest index value), and, in a subsequent step 218, the search operation is performed within said block.

If the data sought have been located (output YES from a verification step designated by 220), the system passes on to the step 206 corresponding to the data having been found.

If, instead, the file sought is not found in the block being checked (output NO from step 220), the unit 30 starts a recursive procedure of scanning of the other blocks (according to a predefined criterion, for example considering the index in descending order with respect to the evaluated one).

In the flowchart of FIG. 6, step 222 corresponds to the verification of whether all the blocks have been effectively checked. Said verification yields a negative result as long as there still exist blocks to be checked (without the data having been retrieved, hence with output NO from step 220). The output YES from step 222 indicates that all the blocks have been checked so that the system passes on to a final step designated by 224. This procedure corresponds basically to a worst case, in which the unit 30 in practice scans all the memory blocks; this, however, corresponds simply to the operation of a normal storage system according to the known art.

As regards block 208 of FIG. 6, it may be considered, for example, that the user wishes to seek a particular image, without, however, knowing where the corresponding file has been stored and having available only partial information such as, for example, the date of creation of the file and the adjustments of a camera. This available information can then be used as input information for the module 60, which is able to use these metadata as input of the classifier of the associative memory 40, which is able to return the corresponding index value (centroid).

The solution described herein is to be applied, in a particularly advantageous way, to mass-storage systems of very large dimensions, in which there is required availability of a data-retrieval operation that is efficient also in the cases where precise information on the location of the data is not available. Even though specific reference is made herein to a so-called VLMSS, the mass-storage device can be any mass-storage device.

Of course, the solution described herein proves particularly advantageous when the mass-storage system is of particularly large dimensions. Another advantage of the solution described, as compared to the known art, is represented by its intrinsic capacity for storing information through an adaptive process based upon the content integrated in the architecture of the mass-storage device. This in general enables execution of search operations that are efficient and less costly in terms of time. As has been seen, data with similar content are stored in the same blocks of the storage device 20, and consequently the search for them can be made directly in those blocks and not in others. The list that contains the correspondence between the blocks (Bᵢ) and the associated index (C_val) is updated whenever new data are recorded in the block, taking into consideration the characteristics (i.e., the index) of the input data.

Without prejudice to the principle of the invention, the details of implementation and the embodiments may vary, even significantly, with respect to what is illustrated herein purely by way of non-limiting example, without thereby departing from the scope of the invention, as defined by the annexed claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A method for storing and retrieving data, the method comprising:
providing a storage device with a plurality of memory blocks,
organizing data to be stored in classes according to their content, and associating to the data thus organized class-of-content identifiers;
storing the data in said storage device at given addresses in said memory blocks according to said class-of-content identifiers, so that data associated with a given class-of-content identifier are stored in at least one corresponding block; and
retrieving the data stored in said storage device:
(i) if a storage address is available, by retrieving the data at the respective storage address; or
(ii) if the storage address is not available, by seeking the data according to the corresponding class-of-content identifiers, and conducting a search in the memory blocks corresponding to said class-of-content identifiers.

2. The method according to claim 1, further including seeking in the data to be stored metadata indicating respective classes of content.

3. The method according to claim 2 wherein said seeking includes deriving said class-of-content identifiers starting from said metadata via a mechanism of associative memory.

4. The method according to claim 1, further including associating to the data to be stored metadata indicating respective classes of content.

5. The method according to claim 1 wherein centroids of said data to be stored are used as class-of-content identifiers.

6. The method according to claim 1, further including creating a table of correspondence between class-of-content identifiers and blocks in said storage device.

7. The method according to claim 6 wherein said storing includes seeking in said table, during storage of the data, a block corresponding to the class-of-content identifiers of the data currently stored, and storing the data in said block thus identified in said table.

8. The method according to claim 6 wherein said storing includes seeking in said table, during storage of the data, a block corresponding to the class-of-content identifiers of the data currently stored and, if said table does not contain a class-of-content identifier corresponding to the class of content of the data stored, determining a class-of-content identifier not yet contained in said table, and storing said data in the corresponding block.

9. A system architecture to store and retrieve data with a storage device organized in a plurality of blocks, the system comprising:
at least one classifying circuit to organize data to be stored in classes according to their content, associate to the data thus organized class-of-content identifiers, so that the data can be stored in said storage device at given addresses in said memory blocks according to said class-of-content identifiers, with data having associated thereto a given class-of-content identifier being stored in at least one corresponding block; and
a unit to read or write the data into the storage device, the data stored in said storage device being retrievable by said unit:
(i) if a storage address is available, by retrieving the data at the respective storage address, or
(ii) if the storage address is not available, by seeking the data according to the corresponding class-of-content identifiers, and conducting a search in the memory blocks corresponding to said class-of-content identifiers.

10. The architecture according to claim 9 wherein said classifying circuit includes a block for search of class of content to seek in the data to be stored metadata indicating respective classes of content.

11. The architecture according to claim 10 wherein said block for search of class of content includes an associative memory.

12. The architecture according to claim 9, further including a metadata-insertion block to insert in the data to be stored metadata indicating respective classes of content.

13. The architecture according to claim 9 wherein centroids of said data to be stored are used as class-of-content identifiers.

14. The architecture according to claim 9, further including a table of correspondence between class-of-content identifiers and blocks in said storage device.

15. An article of manufacture, comprising:
a computer-program product loadable into a memory of at least one computer and including software code portions executable by said computer to perform a method to store and retrieve data, by:
organizing data to be stored in classes according to their content, and associating to the data thus organized class-of-content identifiers;
storing the data in a storage device, having a plurality of memory blocks, at given addresses in said memory blocks according to said class-of-content identifiers; and
retrieving the data stored in said storage device by:
(i) if a storage address corresponding to said data is available, retrieving the data using said available storage address; and
(ii) if said storage address of said data is unavailable, seeking the data according to the corresponding class-of-content identifiers, and conducting a search in the memory blocks corresponding to said class-of-content identifiers.

16. The article of manufacture of claim 15 wherein said software code portions are further executable by said computer to perform said method, by:
seeking in the data to be stored metadata indicating respective classes of content.

17. The article of manufacture of claim 15 wherein centroids of said data to be stored are used as class-of-content identifiers.

18. The article of manufacture of claim 15 wherein said software code portions are further executable by said computer to perform said method, by:
creating a table of correspondence between class-of-content identifiers and blocks in said storage device.

19. An apparatus, comprising:
at least one classifying circuit adapted to organize data to be stored into classes of content, based on content of said data, and further adapted to associate class-of-content identifiers to the data thus organized,
wherein said data is adapted to be stored according to said class-of-content identifiers, said data being adapted to be retrieved:
by use a storage address if said storage address is available; and
by search of said data using its corresponding class-of-content identifier.

20. The apparatus of claim 19, further comprising a storage device having a plurality of memory blocks each having at least one of said storage address, wherein said search of said data using its corresponding class-of-content identifier includes a search in said memory blocks.

21. The apparatus of claim 20, further comprising a unit coupled to said storage device to perform storage and retrieval of said data.

22. The apparatus of claim 19 wherein said classifying circuit includes an associative memory.

23. The apparatus of claim 19 wherein said classifying circuit is adapted to seek in the data to be stored metadata indicating respective classes of content.

24. The apparatus of claim 18 wherein said classifying circuit is adapted to use centroids of said data to be stored as class-of-content identifiers.
